(19) United States
(12) Patent Application Publication
(10) Pub. No.: US 2009/0126921 A1
(43) Pub. Date: May 21, 2009

(54) Method For Brazing A Heat Exchanger Folded Tube While Applying A Flux Near A Contact Zone Of The Walls, Resulting Tube

(76) Inventors: Damien Berges, Yvre le Poline (FR); Frederic Meslin, Nantes (FR)

Correspondence Address: HOWARD & HOWARD ATTORNEYS PLLC, 450 West Fourth Street, Royal Oak, MI, 48067, US

(21) Appl. No.: 11/915,835

(22) PCT Filed: May 29, 2006
(86) PCT No.: PCT/FR2006/001210

§ 371 Date: Jul. 22, 2008

(30) Foreign Application Priority Data
May 30, 2005 (FR) FR0505422
May 29, 2006 (FR) PCT/FR2006/001210

(51) Int. Cl. F28F 1/00; B23P 15/26

(52) U.S. Cl. 165/177; 29/890.053

(57) ABSTRACT

The invention concerns a method for brazing a heat exchanger folded tube (10), including the following operations: contacting a first tube part (20) against a support surface of a second tube part (22) at a contact zone, and brazing the first and second tube parts at said contact zone, using an input of brazing and a brazing flux (32), to form a brazed link. Such a brazing method is particularly suitable for making heat exchanger tubes having a generally B-shaped cross-section and delimiting two parallel channels (30) of fluid flow. However, said brazing method can also be used for making other types of tube from one or several metal bands.

This invention relates to the field of heat exchangers, in particular for motor vehicles.

It relates more specifically to a method for brazing a folded tube of a heat exchanger, including operations consisting of placing a first tube part in contact with a contact surface of a second tube part at the level of a contact area, and brazing the first and second tube parts at the level of this contact area, using a brazing addition and a brazing flow, to form a brazed connection.

Such a brazing method is suitable very specifically for the production of heat exchanger tubes having a general B-shape cross-section and delimiting two parallel fluid circulation channels. However, this brazing method can also be used to produce other types of tubes from one or more metal strips.

In the known brazing methods of this type, the first and the second tube parts are held in contact during the brazing operation, which is normally performed by passing them through a brazing furnace. For this, a plurality of tubes is normally assembled with undulated weld gaps or other types of heat exchange fins, to form a bundle.

The brazing is performed with a brazing addition, usually in the form of a plating on at least one of the faces of the metal strip(s) used to form the tube. This plating is a eutectic compound, of which the melting temperature is lower than that of the carcass of the components to be brazed together.

In addition, the brazing is performed with a brazing flow that is melted in the brazing operation and that is intended primarily to dissolve the oxide layer that is naturally formed on the surfaces to be assembled. This brazing flow is also intended to wet the parts to be brazed and to thus enable the brazing addition to spread over the contact surfaces and to diffuse even to the core of the parts to be brazed.

Until now, the brazing flow has been applied, before the brazing operation, in the contact area between the first tube part and the second tube part. In other words, this flow is applied on the contact surface of the second tube part at the level of the area where the contact will occur.

Such a brazing is now increasingly being performed in a controlled atmosphere, namely in a nitrogen atmosphere, which enhances the brazing capacity of the parts to be assembled. This is a method known as Nocolok®.

Various brazing methods of the type mentioned above are known.

Thus, the U.S. Pat. No. 6,119,341 proposes applying a liquid brazing flow on the interior surface of a metal strip and then drying this flow prior to the brazing operation.

The U.S. Pat. No. 6,412,174 describes a method consisting of applying a flow solution inside a folded tube, during the forming thereof, only on the area to be brazed.

The patent application US 2003/145465 describes another method for applying a flow to the internal surface of a folded tube with a B-shaped cross-section. In this known method, the flow is applied in a solution during the formation of the tube on the area to be brazed.

In all of these known methods, the brazing flow is applied in the form of a solution or suspension, or in the form of a paste, in the contact area, which will become the brazing area.

These known solutions have a number of disadvantages.

First, the deposition of the brazing flow on the area to be brazed forms a coating that can create an additional thickness, especially when said flow is in a pasty form. When the tubes are then stacked to form a heat exchanger bundle, the respective additional thicknesses of the tubes combine to create an increase in the size. This effect is magnified when the number of tubes is high.

These known solutions can therefore raise problems of insertion of fins in the assembly of the bundle due to the additional thickness caused by the brazing flow in the different tubes. Conversely, a sizing of the space between the tubes, intended to compensate for this additional thickness, can cause unsatisfactory brazing of the tube/weld gap connection.

Moreover, these known solutions can lead to a high consumption of the brazing flow due to the thickness of the brazing flow coating.

In addition, these solutions doe not make it possible to apply the flow properly on the area to be brazed. They do not enable a precise application, and they often make it impossible to apply the brazing flow when producing a folded tube directed downward.

These solutions do not enable the method to be reproduced, which results in a lack of reliability of the shape of the folded tube.

The invention is intended in particular to overcome the aforementioned disadvantages.

It thus proposes a brazing method of the type defined in the introduction, in which the brazing flow is first applied to the contact surface of the second part of a tube, under controlled conditions, at a close distance from the contact area.

Thus, unlike in the known solutions, in which the brazing flow is applied to the actual area where contact will occur, the method of the invention applies the brazing flow at a short distance from this area, therefore outside of it.

It has surprisingly been noted that the brazing flow nevertheless performs its usual functions, even though it is not located in the area of contact and therefore the area of brazing.

Without associating this with any particular theory, it appears that the brazing flow, which is melted in the brazing operation, migrates in the contact area of the parts to be brazed, which enables it to dissolve the oxide layer and to wet the parts to be brazed.

This of course assumes that the distance between the brazing flow, forming the coating, and the contact area is small, and therefore controlled.

This distance is advantageously between 0 and 6 mm.

The brazing flow can be applied either on one side of the contact area or on both sides of the contact area.

In either case, the brazing flow is advantageously applied in the form of a band having a width of between 0.5 and 3 mm.

In the invention, the brazing flow is advantageously applied in the form of a paste, for example by means of an application roller.

This brazing flow is applied according to a controlled density, i.e. with a controlled amount per surface unit.

In a preferred embodiment, the brazing flow is a flow for brazing in a controlled atmosphere, and the density is between 2 and 120 grams per square meter.

In a preferred application, the first tube part is a folded end of a metal strip, whereas the second tube part is an internal face of the strip.

Such a tube is advantageously made in the shape of a tube with a B-shaped transverse cross-section, having two circulation channels.

The invention applies very specifically to tubes made with at least one metal strip, advantageously of aluminum.

The brazing addition is advantageously a plating applied to one and/or the other of the two faces of a metal strip.

However, in an alternative embodiment of the invention, the brazing addition and the brazing flow can be jointly applied in the form of a mixture.

This advantageously results in the possibility of applying, instead of the aforementioned brazing flow, a mixture that acts both as a brazing addition and as a brazing flow, which makes it possible to eliminate the plating on the tube surface.

In a preferred embodiment of the invention, the brazing is performed in a controlled nitrogen-based atmosphere.

In another embodiment, the invention relates to a heat exchanger tube capable of being obtained by implementing the method defined above.

This tube is advantageously made of a single metal strip and has a substantially B-shaped transverse cross-section.

Of course, the invention can also be applied to the production of other types of folded tubes, made with one or more metal strips.

In the description below, provided solely as an example, reference is made to the appended drawings, in which:

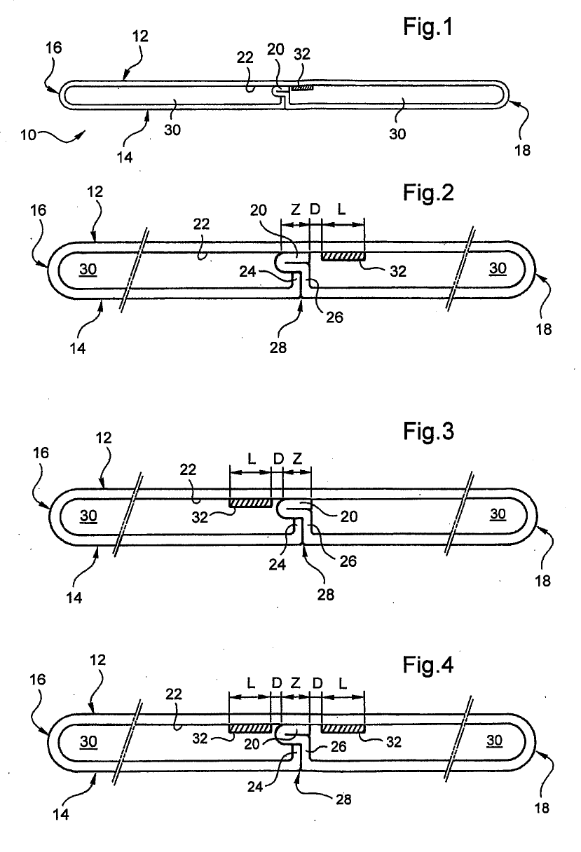

FIG. 1 is a transverse cross-section view of a heat exchanger tube, with a general B-shaped cross-section, after folding and before brazing by means of a method according to the invention;

FIG. 2 is a partial view on an enlarged scale of the tube of FIG. 1;

FIG. 3 is a view similar to FIG. 2 in an alternative embodiment;

FIG. 4 is a view similar to FIG. 2 in another alternative embodiment;

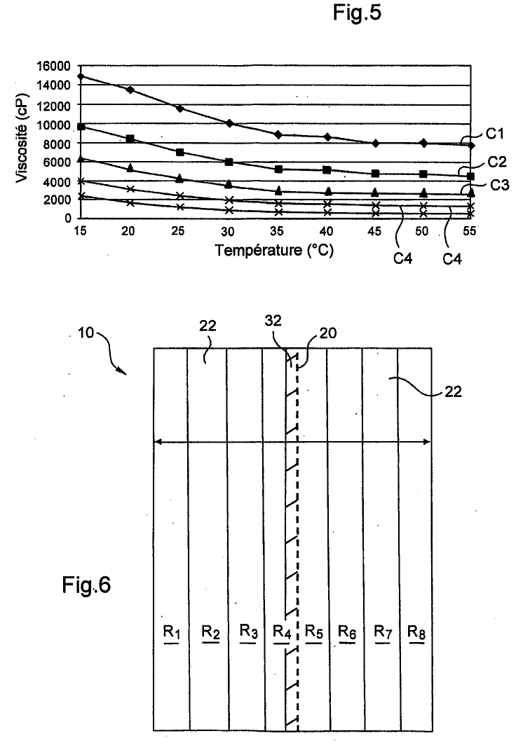

FIG. 5 is a diagrammatic representation of the internal face of a tube according to the invention; and

FIG. 6 is a graph showing the variations in viscosity of a pasty brazing flow as a function of temperature.

Reference is first made to FIG. 1, which shows, in a cross-section view, a heat exchanger tube 10, once formed by folding and before brazing. The tube 10 is made of a metal strip, advantageously based on aluminum, and has two generally parallel faces 12 and 14 joined by two small faces 16 and 18 with a U-shaped cross-section.

The tube includes a first part 20 obtained by folding a first marginal region of the strip and coming into contact with a contact surface of a second tube part 22. This second tube part is formed in this case on the internal surface of the large face 12. This part 22 is directed downward, as can be seen in FIG. 1 and in the enlarged view of FIG. 2.

The other marginal region 24 of the strip is folded and applied against a part 26 of the strip to jointly form a partition 28, which makes it possible to define two parallel fluid circulation channels 30. The general shape of the transverse cross-section of such a tube is known per se. It is noted that the first tube part 20 is applied at the level of a contact area Z (FIG. 2), which subsequently constitutes a brazing area.

The brazing of such a tube is conventionally performed with the use of a brazing addition and a brazing flow. The brazing addition is usually formed by a plating applied on the internal face and/or the external face of the strip. In this case, this plating is advantageously applied on the internal face of the strip, i.e. also on the second tube part 22.

As indicated above, a brazing flow is also used to enhance the brazing method. As can be seen in FIG. 1, and more specifically in the enlarged view of FIG. 2, the method of the invention consists of first applying a brazing flow 32 on the contact surface of the second tube part 22, under controlled conditions, and at a close distance D from the contact area Z. This distance D is controlled and is advantageously between 0 and 6 mm.

In the example of FIGS. 1 and 2, the brazing flow 32 is applied on one side of the contact area Z, i.e. in this case on the right-hand side. The brazing flow is applied in the form of a narrow band having a width L of between 0.5 and 3 mm.

In a preferred embodiment of the invention, the brazing flow is applied in the form of a paste, under controlled conditions. Surprisingly, it was noted that during the brazing, which is performed in a furnace at a temperature high enough to melt the brazing addition, this brazing flow migrates into the region of the contact area and performs its usual functions.

Thus, the brazing flow, once it has melted, dissolves the oxide layer naturally formed on the surface of the parts to be assembled. In addition, the flow wets the parts to be brazed and thus enables the brazing addition to spread over the contact surfaces. This migration of the molten brazing flow is also promoted by the contact pressure, which pushes the tube parts 20 and 22 toward one another.

Because the brazing flow 32 is applied outside of the contact area Z, it does not lead to additional thicknesses capable of modifying the width of the tube, i.e. the distance between faces 12 and 14.

This is particularly important when brazing, in a single operation, a bundle of tubes comprising a large number of tubes and fins or undulated weld gaps placed between two adjacent tubes.

By not creating an additional thickness in the contact area of the tube, it is possible to repeat the process with a reproducible size of the tubes, and therefore of the heat exchange bundle.

FIG. 3 shows another alternative embodiment in which the brazing flow 32 is applied on the other side of the contact area Z, i.e. on the left-hand side in the example shown.

FIG. 4 shows yet another alternative embodiment in which the brazing flow 32 is applied in the form of two parallel bands respectively on the two sides of the contact area Z.

The method of the invention is advantageously performed in a controlled atmosphere, in particular in a nitrogen atmosphere, with the so-called Nocolok® method. It is advantageous in this case to use a pasty mixture including a brazing flow known for the Nocolok method, in a mixture with a binder and a thickening agent.

In the invention, the brazing flow is applied according to a controlled density, i.e. in a controlled mount, generally between 2 and 120 g/m². The greater the distance D, the higher the flow density must be. Thus, for example, if the pasty flow is applied at a distance of 6 mm from the area Z, it is necessary either to increase the width of the coating (3 mm of width for an application density of 20 g/m²), or to increase the application density of the brazing flow (0.5 mm of width for an application density of 120 g/m²).

The application of the brazing flow is advantageously performed continuously on a production bench using an application roller. The brazing flow is then applied on a non-degreased metal sheet, continuously unrolled from a reel. The strip is then folded on the production bench in order to give it the desired transverse cross-section, then cut into segments constituting individual tubes. The tubes thus obtained are then assembled with fins, for example undulated weld gaps, to form a bundle that can be brazed in a single operation by passing it through a brazing furnace.

For example, we used a pasty formulation with the following ingredients in the weight proportions indicated:

45% (±1%) Nocolok® flow

10% (±0.5%) of N-methyl-2-pyrrolidone

10% (±0.5%) 2-butoxyethanol

35% (±1%) demineralized water.

In the example of a tube as described above, the brazing flow coating is applied in the form of a band over a width L of 1.5 mm and at a distance D from the area Z of between 2 and 2.5 mm. The brazing flow in the form of a paste is applied by coating with a roller on an oily surface. The application density of the brazing flow in this case is 49 g/m².

FIG. 5 shows the variations in the viscosity of the pasty mixture as a function of temperature and the agitation speed of the mixture. FIG. 5 shows different curves C₁ to C₅ representing the variations in viscosity expressed in centipoises (cP) as a function of the temperature (° C.) for different mean agitation values, namely 3 turns/min (curve C₁), 6 turns/min (curve C₂), 12 turns/min (curve C₃), 30 turns/min (curve C₄), and 100 turns/min (curve C₅). The higher the agitation speed, the lower the viscosity. The viscosities range from around 2000 to 15000 cP at 15° C. and around 1000 to 8000 cP at 55° C. It is understood that it is thus possible to control the viscosity of the pasty mixture that will be applied on the tube before brazing.

Various tests were performed on heat exchange tubes obtained by the method of the invention, and made it possible to note that these tubes had bursting strengths comparable to those of tubes obtained by known methods, i.e. in which the brazing flow is applied on the area of contact of the parts to be brazed.

FIG. 6 diagrammatically shows a tube part according to the invention, in this case the internal side of the face 12, on which the contact area Z and the region of the brazing flow 32 are shown. The internal width of the tube is typically 27 mm or more. It is symbolically divided into eight regions R₁ to R₈ in the form of parallel bands from left to right in the drawing. The brazing flow is applied on a part of region R₄, and the location of the second tube part 22 is shown by a mixed line between regions R₄ and R₅. In regions R₄ and R₅ near the location of the brazing flow, and a macroscopic analysis shows the presence of the flow.

Indeed, we find in region R₄ numerous platings and fins showing the presence of the flow. In regions R₃ and R₅ located on each side of region R₄, the analysis shows fins and few platings still showing the presence of the flow. By contrast, in the other regions R₁ and R₂ (left-hand side) and R₆, R₇, and R₈ (right-hand side), no trace is seen of fins showing the presence of the flow.

The observations show that the flow that was applied in the region Z migrated on each side of this region, over a limited range, and was thus capable of performing its usual functions.

As indicated above, it is possible to jointly apply the brazing addition and the brazing flow in the form of a mixture, which then makes it possible to eliminate the plating.

If the tube to be brazed is made of aluminum, this mixture will comprise a silicon compound, making it possible during the brazing to produce a eutectic product with the aluminum of the carcass. In this case, the application of the mixture near the point to be brazed prevents the need to plate the entire surface to be brazed. This mixture is advantageously chosen from the following possibilities:
a so-called “Silflux” mixture, comprising 33% by weight of silicon powder, Nocolok® 100 flow and 66% binder, applied in an amount of 3 to 6 grams of silicon per m² of surface;
an AlSi12 compound comprising the Nocolok® flow, and a compound similar to the eutectic AlSi12, applied in an amount of 4 to 10 grams of AlSi12 per m² of surface; and
a paste to be brazed comprising AlSi12 in the form of a paste and a brazing flow.

The invention thus makes it possible to produce various types of heat exchanger tubes. They can be tubes each obtained with a single strip or with a plurality of strips.

Aside from tubes with a B-shaped cross-section, it is possible to produce tubes having a part forming an insert with undulations in order to define a multitude of parallel channels. In this case, the part that forms undulations can be made in the form of an insert separated from another strip, or from the same strip.

Similarly, it is possible to form tubes comprising a plurality of adjacent channels, delimited by walls constituted by folds formed in the material of the external wall of the tube.

The invention can be applied in particular in heat exchangers for motor vehicles.

1. A method for brazing a folded tube of a heat exchanger, comprising placing a first tube part (20) in contact with a contact surface of a second tube part (22) at the level of a contact area (Z), and brazing the first and second tube parts at the level of this contact area, using a brazing addition and a brazing flow, to form a brazed connection,
characterized in that the brazing flow (32) is first applied on the contact surface of the second tube part (22) under controlled conditions, at a close distance (D) from the contact area (Z).

2. A method according to claim 1, characterized in that the distance (D) is between 0 and 6 mm.

3. A method according to claim 1, characterized in that the brazing flow (32) is applied on one side of the contact area (Z).

4. A method according to claim 1, characterized in that the brazing flow (32) is applied on both sides of the contact area (Z).

5. A method according to claim 1, characterized in that the brazing flow (32) is applied in the form of a band having a width (L) of between 0.5 and 3 mm.

6. A method according to claim 1, characterized in that the brazing flow (32) is applied in the form of a paste.

7. A method according to claim 6, characterized in that the brazing flow (32) is applied according to a controlled density.

8. A method according to claim 7, characterized in that the brazing flow (32) is a flow for brazing in a controlled atmosphere, and the density is between 2 and 120 grams per square meter.

9. A method according to claim 1, characterized in that the first tube part (20) is a folded end of a metal strip, whereas the second tube part (22) is an internal face of the strip.

10. A method according to claim 1, characterized in that the tube (10) is made from at least one metal strip.

11. A method according to claim 1, characterized in that the brazing addition is a plating.

12. A method according to claim 1, characterized in that the brazing addition and the brazing flow are jointly applied in the form of a mixture.

13. A method according to claim 1, characterized in that the brazing is performed in a controlled nitrogen-based atmosphere.

14. A heat exchanger tube obtained by the method of claim 1.

15. A heat exchanger tube according to claim 14, characterized in that it is made of a single metal strip and has a substantially B-shaped transverse cross-section.

16. A method according to claim 2, characterized in that the brazing flow (32) is applied on one side of the contact area (Z).

17. A method according to claim 2, characterized in that the brazing flow (32) is applied on both sides of the contact area (Z).

18. A method according to claim 6, characterized in that the brazing flow (32) is applied according to a controlled density.

19. A method according to claim 2, characterized in that the brazing flow (32) is applied in the form of a band having a width (L) of between 0.5 and 3 mm.

20. A method according to claim 2, characterized in that the brazing addition and the brazing flow are jointly applied in the form of a mixture.
